(19) United States
(12) Patent Application Publication
(10) Pub. No.: US 2015/0207836 A1
(43) Pub. Date: Jul. 23, 2015

(54) SYSTEM AND METHOD FOR MULTIPLEX STREAMING OF MOBILE DEVICES

(71) Applicant: Next Level Security Systems, Inc., Carlsbad, CA (US)

(72) Inventors: Peter A. Jankowski, Rancho Santa Fe, CA (US); Rand D. Anderson, Cardiff, CA (US)

(73) Assignee: Next Level Security Systems, Inc., Carlsbad, CA (US)

(21) Appl. No.: 14/158,400

(22) Filed: Jan. 17, 2014

(51) Int. Cl. H04L 29/06; H04L 29/08; H04L 12/26

(52) U.S. Cl. CPC H04L 65/4076; H04L 43/04; H04L 67/02

(57) ABSTRACT

A system for broadcasts from mobile devices is described. The system includes a gateway, a web server, and a first and second mobile device. The web server introduces the mobile devices to the gateway. The gateway authenticates the mobile devices and communicates with the first mobile device and the second mobile device. The gateway multiplexes a first video stream and a second video stream at the first mobile device. A stream module of the gateway receives the first video stream from the first mobile device. A control module of the gateway receives a command from the first mobile device to remotely control the second mobile device to generate the second video stream from the second mobile device. A broadcast module of the gateway broadcasts the second video stream to the first mobile device while receiving the first video stream from the first mobile device.

### TECHNICAL FIELD

This application relates generally to the field of computer technology, and in a specific example embodiment, to a system for multiplex streaming of video from mobile devices.

### BACKGROUND

Systems for monitoring and/or controlling security devices have become increasingly popular in recent years. Such systems are used to communicate with security devices such as lights, thermostats, or security systems.

Some conventional systems for controlling and monitoring security devices allow a user to access a server from a remote location using a device such as a desktop computer. For example, a user can use a desktop computer located in a remote location to connect with the server. The user can then send commands to the server to control various security devices. For example, the user can turn lights on or off. In another example, the user accesses a video feed stored at the server that receives a video stream from a camera at a monitored location.

Such conventional systems for controlling and/or monitoring security devices have at least the following disadvantages and limitations. The connection between the user's remote computer and the server may not be secured. A user could establish a secure connection, but the cost and complexity involved in establishing such a connection are high. Such systems are also complex for users to implement and maintain. For example, the server may be difficult to install and configure. Programming such systems can also be cumbersome and need custom configurations when adding supplemental security devices or services. Last, it is difficult for the user to access the server using different types of remote devices. For instance, conventional systems only allow a user to access the offsite server using, for example, a secured desktop computer located in the user's workplace.

### BRIEF DESCRIPTION OF THE DRAWINGS

The present inventive subject matter is illustrated by way of example, and not by way of limitation, in the figures of the accompanying drawings in which:

FIG. 1 is a network diagram depicting a network system, according to one embodiment, for exchanging data over a network;

FIG. 2 is a block diagram illustrating an example embodiment of a wireless mobile communication device;

FIG. 3 is a block diagram illustrating an example embodiment of an application module in the device;

FIG. 4 is a block diagram illustrating an example embodiment of a gateway;

FIG. 5 is a block diagram illustrating another example embodiment of a gateway;

FIG. 6 is a block diagram illustrating an example embodiment of a web-based monitoring application of a gateway;

FIG. 7 is a block diagram illustrating an example embodiment of a web server;

FIG. 8 is a ladder diagram of an example embodiment of a method for multiplex streaming between a first device and a second device connected to a gateway;

FIG. 9 is a ladder diagram of an example embodiment of a method for multiplex streaming and control between a first device and a second device connected to a gateway;

FIG. 10 is a ladder diagram of an example embodiment of a method for controlling from a first device multiplex stream from a second device to a third device connected to a gateway;

FIG. 11 is a ladder diagram of an example embodiment of a method for requesting, from a first device, distributive analytics of streams from a second device with third, fourth, and fifth devices;

FIG. 12 is a ladder diagram of an example embodiment of a method for peer to peer multiplex streaming;

FIG. 13 is a ladder diagram of another example embodiment of a method for peer to peer multiplex streaming;

FIG. 14 is a flow diagram of an example embodiment of a method for multiplex streaming of devices associated and connected to a gateway;

FIG. 15 is a flow diagram of another example embodiment of a method for multiplex streaming of devices associated and connected to a gateway;

FIG. 16 is a flow diagram of an example embodiment of a method for distributive analytics of streams from devices associated and connected to a gateway;

FIG. 17 is a flow diagram of an example embodiment of a method for peer to peer streaming of devices associated and connected to a gateway;

FIG. 18 is a flow diagram of another example embodiment of a method for peer to peer streaming of devices associated and connected to a gateway; and

FIG. 19 shows a diagrammatic representation of machine in the example form of a computer system within which a set of instructions may be executed to cause the machine to perform any one or more of the methodologies discussed herein.

### DETAILED DESCRIPTION

Although the present inventive subject matter is described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

In various embodiments, a system for broadcasts from mobile devices is described. The system includes a gateway, a web server, and a first and second mobile device. The web server introduces the mobile devices to the gateway. The gateway authenticates the mobile devices and communicates with the first mobile device and the second mobile device. The gateway multiplexes a first video stream and a second video stream at the first mobile device such that the mobile device can broadcast a stream to the gateway while receives another stream from the gateway. A stream module of the gateway receives the first video stream from the first mobile device. A control module of the gateway receives a command from the first mobile device to remotely control the second mobile device to generate the second video stream from the second mobile device. A broadcast module of the gateway broadcasts the second video stream to the first mobile device while receiving the first video stream from the first mobile device.

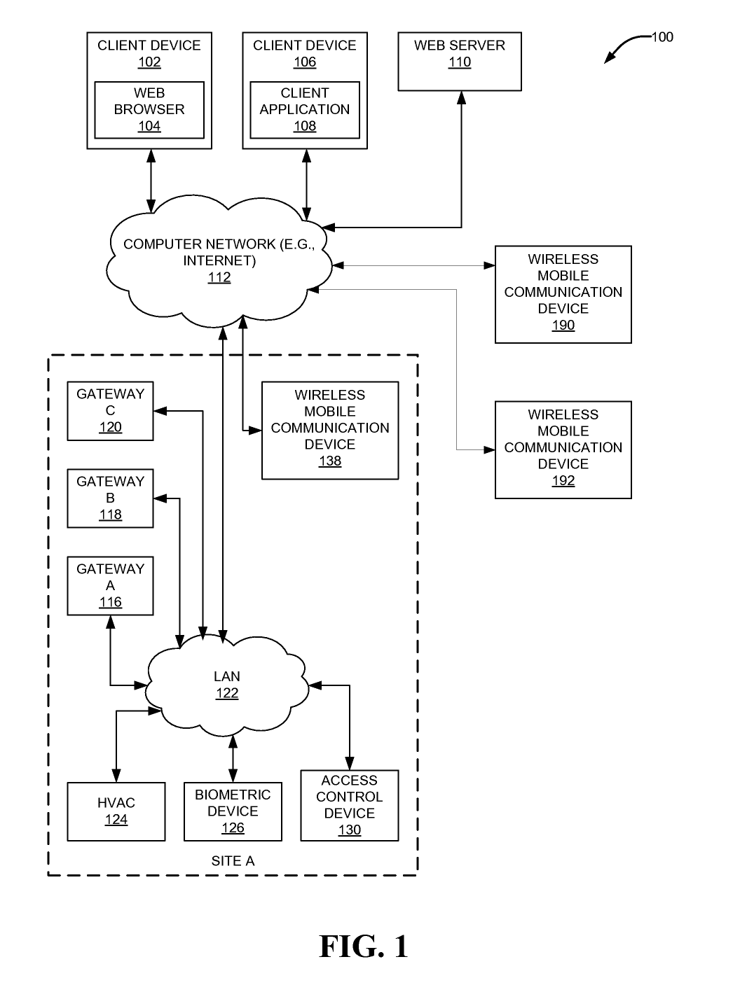

FIG. 1 is a network diagram depicting a network system 100, according to one embodiment, for exchanging data over a computer network 112 (e.g. TCP/IP network). For example, the network system 100 comprises client devices 102, 106, a web server 110, gateways 116, 118, 120, a wireless mobile communication device 138 at a location site A; wireless mobile communication devices 190, 192 may be outside the location site A. Another gateway may be located at a location site B. For example, location site A may be a retail store in a city and location site B may be an office space in another city. A location site may include, for example, one or more floors of an office building, a residential house, an area of a factory or retail space, and so forth. In another example, location sites may overlap each other.

For purposes of the present embodiment, the terms “sites” and “premises” refer to any location to be monitored, whether residential, commercial, public, or secured. Further, the term “a” is generally used in the present disclosure to mean one or more. Still further, the terms “coupled” and “operatively coupled” mean connected in such a way that data may be exchanged. It is understood that “coupled” and “operatively coupled” do not specify a direct connection, a wired connection, or even a permanent connection. It is sufficient for purposes of the present embodiment that the connection(s) be established for the sole purpose of exchanging information.

The wireless mobile communication device 138 and the client devices 102, 106 are connected to the computer network 112. The wireless mobile communication device 138 includes, for example, a smart phone with a camera. The client devices 102, 106 can include, but are not limited to, a desktop computer, a laptop computer, a mobile computing device, and the like. A network interface in the client devices 102, 106 and the wireless mobile communication device 138 enable them to send and receive data to and from the computer network 112. The wireless mobile communication device 138 may communicate indirectly via a cellular tower signal, directly via a WiFi signal, or via other means to the network 112.

The client device 102 may include a web browser 104 that may be in communication with the web server 110 via the computer network 112. In another example, the client device 106 includes a programmatic client, such as a client application 108 configured to communicate with the web server 110 via the computer network 112. The web browser 104 or the client application 108 may be used to display some or all of the information and monitoring data provided by gateways 116, 118, and 120.

The wireless mobile communication device 138 may include a web browser, a client application, or a mobile application (app) configured to access the web server 110 via the computer network 112, and to communicate with corresponding gateways. The wireless mobile communication device 138 may be located at a site corresponding to a gateway (e.g., site A corresponding to gateway 116) or outside a site.

The computer network 112 can include a local area network (LAN) where Gigabit Ethernet switches are used to switch data. In another example, the computer network 112 includes a wide area network, such as the Internet. In general, computer network 112 may be a public network or private network, a single network or a combination of several networks. In most embodiments, computer network 112 may be, but is not required to be, an IP-based network. In some embodiments it may be desirable for all or a portion of network 112 to include publicly available networks, such as the Internet, to avoid the need for installing, purchasing, or leasing additional infrastructure.

The web server 110 may also connect to the computer network 112 both to receive and transmit data. The web server 110 may also be referred to as a web-based host, a directory server, an introduction server, or an application server. The web server 110 is connected to the computer network 112 by a means of a network interface. The network interface can take the form of a network interface card (not shown) installed within the web server 110 to enable data to be sent and received to and from the computer network 112 by the web server 110.

In one embodiment, the web server 110 identifies one or more gateway(s) for the wireless mobile communication device 138 and the client devices 102, 106 to communicate with, so as to monitor and/or control the security devices connected to the corresponding gateway(s). The monitoring may include multiplexing of video feeds to and from the wireless mobile communication device 138. For example, the wireless mobile communication device 138 may broadcast a video stream captured from its camera to the gateway 116 while receiving a video stream from another wireless mobile communication device 190, 192.

In one embodiment, the web server 110 may provide server-side functionality, via the computer network 112, to the wireless mobile communication device 138 and the client devices 102, 106. The wireless mobile communication device 138 and the client devices 102, 106 may enable users that utilize the network system 100 and more specifically, the web server 110, to view monitoring data (e.g. audio/video feed) from security devices connected to gateways 116, 118, 120 over the computer network 112. These transactions may include transmitting, receiving (communicating) and processing data to, from, and regarding monitoring data and users of the network system 100. The data may include, but are not limited to audio, video, picture, metadata, camera configuration data, client device configuration data, and network data monitoring data. The web server 110 can provide other functions including storing monitoring data to an internal or external disk storage device (not shown), playing back recorded monitoring data, and performing analytics.

In another embodiment, the web server 110 may provide server-side functionality, via the computer network 112, to the client devices 102, 106. The client devices 102, 106 may enable users that utilize the network system 100 and more specifically, the web server 110, to view monitoring data (e.g. audio/video feed, lock status, etc . . . ) from the camera of the wireless mobile communication device 138 over the computer network 112.

In one embodiment, the web server 110 may include a directory of gateways, a directory of groups of mobile devices forming a mesh or a peer to peer network, the location of corresponding connected security devices. The web server 110 is described in more detail below with respect to FIG. 7. As such, the web server 110 may correlate the gateway 116 from site A and to gateway from site B. In one embodiment, the correlation may be generated pursuant to pre-defined settings or configuration based on user profile, organization topology, hierarchy, bandwidth and other factors. For example, a user at client device 102 may be a manager responsible for stores located on the West coast. If both sites A and B are on the West coast, the web server correlates gateway 116 to the other gateway. As such, based on the user profile and the organization topology, the user can access only gateway 116 to obtain monitoring data from sites A and B. In other words, the user does not have to communicate directly with several gateways to monitor all security devices attached to the corresponding gateways. In another embodiment, the web server 110 may correlate gateway 116 with other gateways. In yet another embodiment, the other gateways may be correlated with other gateways. For example, information from other gateways correlated with the other gateway which is correlated with gateway 116 may be communicated with the user at the client device 102 or 106.

Generally, gateways 116, 118, 120 include a processor-based device that operates to monitor conditions at a target site or premise, to analyze monitoring data, to detect alarm conditions at the target site or premise, to capture information relating to such alarm conditions, and to send such monitoring information to client devices 102, 106 and/or the web server 110.

Gateways 116, 118, and 120 are located at the same site A. In one embodiment, gateways 116, 118, 120 are capable of balancing their respective load. Furthermore, gateways 116, 118, 120 may provide a redundant backup of each other. Gateways 116, 118, 120 are connected to a local area network LAN 122. In another embodiment, gateways 116, 118, 120 communicate with one another via a peer-to-peer network.

Security devices (e.g. monitoring devices and controlling devices) 124, 126, and 130 are connected to the gateways 116, 118, 120 via LAN 122. Monitoring devices include, for example, sensors. The gateways 116, 118, 120 are not limited to connect to any specific type or model of sensors or monitoring devices. Any sensor may be used, depending on the desired type and level of protection. Examples include, without limitation, microphones, cameras, magnetic contact switches, audio sensors, infrared sensors, motion detectors, fire alarms, and carbon monoxide sensors. For illustration purposes, location site A in FIG. 1 includes a biometric device 126 (e.g. fingerprint reader), and an access control device 130 (e.g. door/gate access sensor).

In addition, controlling devices may include devices that can be controlled such as a HVAC system 124 (e.g. heater/air conditioning system including thermometer, smoke sensor, thermostat), a gate/door lock, and a camera positioning system (e.g. tilt, pan).

The HVAC system 124, the biometric devices 126, and the access control device 130 are located at site A and are connected to the gateway 116 via LAN 122.

The other gateway may be located at location site B; that is, at another location away from location site A (e.g. different physical locations). In another embodiment, gateways 116, 118, and 120 from site A communicate with the other gateway from location site B. As such, client devices 102, 106 can monitor data from monitoring devices, such as audio/video devices and RFID devices connected to the other gateway by communicating only with the gateway 116.

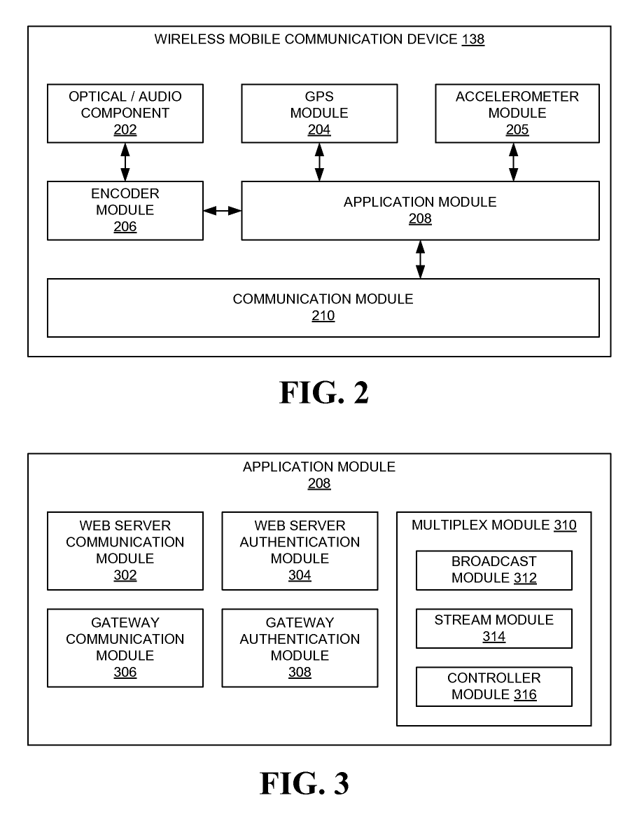

FIG. 2 is block diagram of an example embodiment of the wireless mobile communication device 138. The wireless mobile communication device 138 includes an optical/audio component 202, a GPS module 204, an accelerometer module 205, an encoder module 206, an application module 208, and a communication module 210.

The optical/audio component 202 includes, for example, an optical device such as a camera lens for capturing a picture or video data and/or a microphone for capturing sound. The optical/audio component 202 may capture an analog or digital video and/or audio data. The video and audio data are captured by the optical/audio component 202 in raw format. The encoder module 206 receives the raw video/audio and is configured to encode the video in a variety of formats (MPEG 2, MPEG4, MP3, etc.). The communication module 210 communicates the encoded media data (audio data and/or video data) to a corresponding gateway. The communication module 210 may include a network interface configured to communicate with the computer network 112 of FIG. 1. The GPS module 204 comprises a location detection component configured to determine a geographic location of the wireless mobile communication device 138. The location data generated by the GPS module 204 is associated with the encoded video data from the encoder module 206. The accelerometer module 205 determines a direction and movement of wireless mobile communication device 138 and generates motion data. In one embodiment, the motion data may also be included in the media data as meta data.

The application module 208 enables the wireless mobile communication device 138 to authenticate a user with the web server 110 and corresponding gateways introduced by the web server 110. The application module 208 allows a user at the wireless mobile communication device 138, upon authentication, to send and receive video streams to and from devices associated with the gateway 116. In another embodiment, the application module 208 allows the user at the wireless mobile communication device 138 to remotely control other devices associated with the gateway 116. For example, the wireless mobile communication device 138 may record video/audio from its camera or from another camera of another device and stream the media data to the corresponding gateway.

FIG. 3 illustrates an example embodiment of the application module 208. The application module 208 includes a web server communication module 302, a web server authentication module 304, a gateway communication module 306, a gateway authentication module 308, and a multiplex module 310. The web server communication module 302 enables the wireless communication device 138 to contact and communicate with the web server 110. The web server authentication module 304 authenticates a user of the wireless mobile communication device 138 with the web server 110. Upon successful authentication, the web server 110 introduces the wireless mobile communication device 138 to a corresponding gateway associated with the user or with the wireless mobile communication device 138. The gateway communication module 306 enables the wireless mobile communication device 138 to communicate with the corresponding gateway. The gateway authentication module 308 authenticates a user of the wireless mobile communication device 138.

The multiplex module 310 enables the device 138 to view at least a video stream or a video feed from another device while broadcasting a video stream from the device itself. For example, the multiplex module 310 allows the device 138 to have the gateway 116 record and store the video stream at the gateway 116 or at the web server 110, to control other devices, to select which devices to broadcast and to select which devices to receive the broadcast or video stream from another device. In one example embodiment, the multiplex module 310 includes a broadcast module 312, a stream module 314, and a controller module 316.

The broadcast module 312 enables the wireless mobile communication device 138 to generate a video stream to the corresponding gateway 116 from data captured with the camera of the wireless mobile communication device 138. The video stream may be a live stream or a prerecorded video stream stored in the wireless mobile communication device 138.

The stream module 314 enables the wireless mobile communication device 138 to receive a video stream or feed from other devices associated with the corresponding gateway 116.

The controller module 316 enables the wireless mobile communication device 138 to monitor and control devices (e.g., camera, security) connected to the corresponding gateway 116. Examples of controls include turning the other devices on or off, turning the video stream from the other devices on or off, sending a command to record a video stream from one device to another device associated with the gateway.

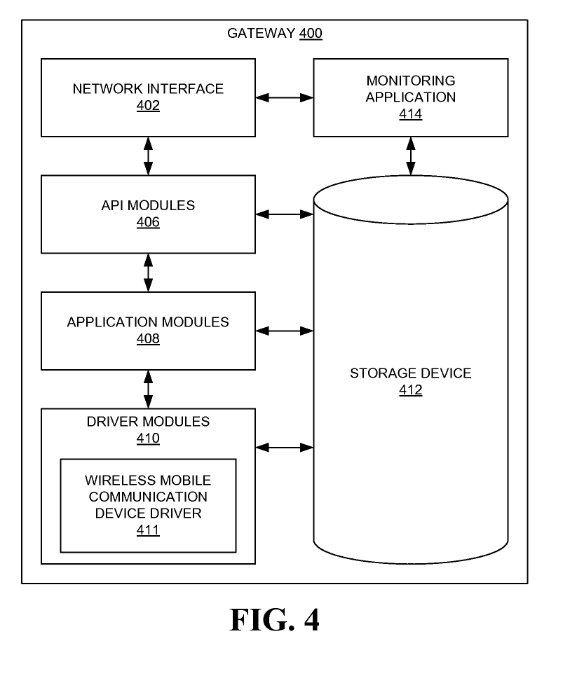

FIG. 4 is a block diagram illustrating an example embodiment of a gateway 400. The gateway 400 includes a network interface 402, API modules 406, application modules 408, driver modules 410, a monitoring application 414, and a storage device 412. The network interface 402 enables the gateway 400 to communicate with the computer network 112. The application programming interface (API) modules 406 enable the gateway 400 to interface the gateway 400 with the wireless mobile communication device 138, the client devices 102, 106, the web server 110, and other third party devices (not shown). The application modules 408 enable the gateway 400 to monitor or control the corresponding monitoring or controlling devices connected to the gateway 400. In addition, the application modules 408 enable the gateway 400 to provide add-on expandable services discussed further below. The driver modules 410 include device drivers to enable interaction of the application modules 408 with the hardware of the corresponding monitoring or controlling devices. In one embodiment, the driver modules 410 include a wireless mobile communication device driver 411 configured to interface with the camera of the wireless mobile communication device 138.

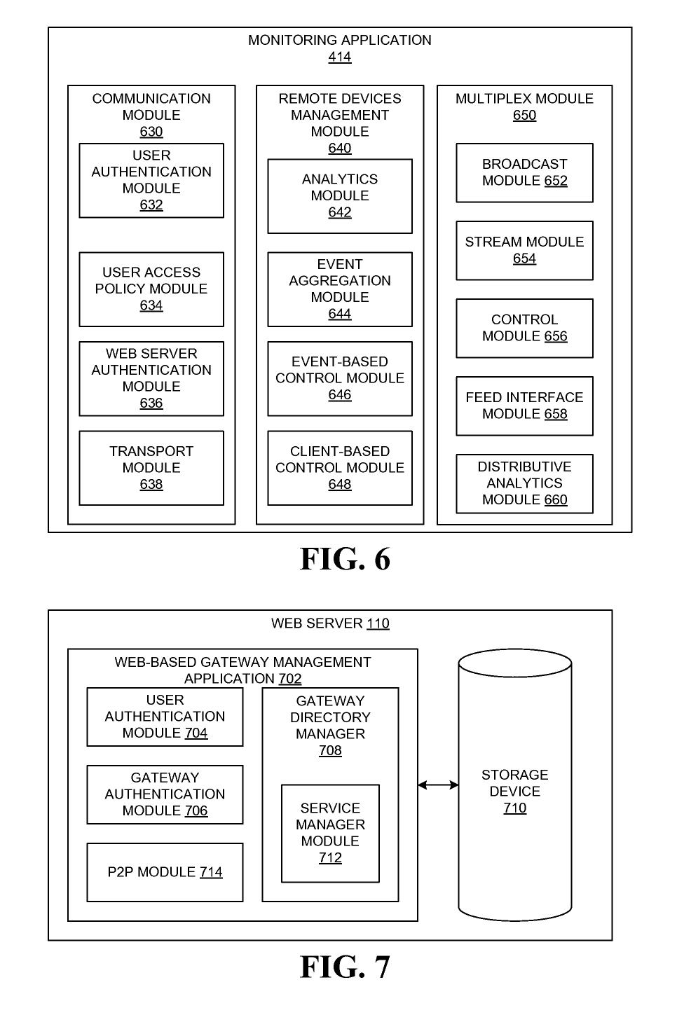

The monitoring application 414 enables the gateway 400 to communicate monitoring and controlling data to and from the client devices and mobile devices. In one embodiment, the monitoring application 414 may include a web-based monitoring application that can be accessed from any web-browser. The monitoring application 414 is discussed in more detail with respect to FIG. 6. The storage device 412 may be used to store video data from the wireless mobile communication device 138, monitoring data from the monitoring devices connected to the gateway 400, APIs from API modules 406, software application from application modules 408, device drivers from driver modules 410, and a configuration of the gateway 400. For example, the configuration of the gateway 400 may include a topology or hierarchy of at a user level, organization level, partner level. The configuration of the gateway may include specifically an enterprise configuration of gateway (based on the topology/hierarchy previously mentioned). In one embodiment, the configuration of the gateway 400 may be replicated to other gateways that are correlated by the web server based on the topology/hierarchy. For example, some gateways can have access control to a limited number of security devices. In another embodiment, each gateway may be custom configured. In another embodiment, the gateway 400 is configured to aggregate data from multiple gateways (that may be correlated by the web server 110 based on the topology) and present the aggregated data to the client device.

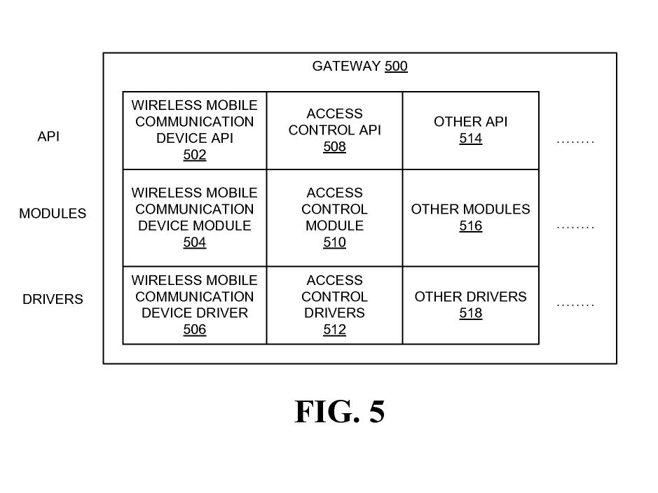

FIG. 5 is a block diagram illustrating another example embodiment of a gateway 500. For example, the gateway 500 includes a wireless mobile communication device API 502, a wireless mobile communication device module 504, and a wireless mobile communication device driver 506. The wireless mobile communication device API 502 provides an interface to the web browser 104 or the client application 108 of the client device 106 to receive and send data from the wireless mobile communication device associated with the gateway 500. The wireless mobile communication device module 504 enables the client device 106 to receive data (e.g. audio and/or video) from the camera of the wireless mobile communication device 138 via the wireless mobile communication device API 502. In another embodiment, the wireless mobile communication device module 504 enables the client device 106 to send requests (e.g. focus, tilt, pan, zoom) to the wireless mobile communication device 138 via the wireless mobile communication device API 502. The wireless mobile communication device driver 506 includes one or more drivers for different brand or manufacturer of wireless mobile communication devices.

In another example, the gateway 500 also includes an access control API 508, an access control module 510, and access control drivers 512. The access control API 508 provides an interface to the web browser 104 or the client application 108 of the client device 102 or 106 to receive and send data from an access control device (e.g. a door access at a monitored site) connected to the gateway 500. The access control module 510 enables the client device to receive data (e.g. time and ID log of the door access at the monitored site) from the access control device via the access control API 508. In another embodiment, the access control module 510 enables the client device to send data (e.g. open, close, lock door) to the access control device via the access control API 508. The access control drivers 512 include one or more drivers for different brand or manufacturer of access control devices.

One benefit of one of the embodiments of the gateway 500 is the ability to easily connect additional devices or third party devices. This is illustrated with respect to other APIs 514, other modules 516, and other drivers 518. As such, the gateway 500 is not limited to any particular manufacturer of devices or brand of devices. The gateway 500 allows for easy expansion and plug-in features using additional APIs, corresponding modules, and corresponding device drivers.

FIG. 6 is a block diagram illustrating an example embodiment of the monitoring application 414 of the gateway 400. The monitoring application 414 enables client devices to remotely monitor and control other devices connected to the gateway 400 and to send and receive video streams to and from other devices or between other devices.

In one example embodiment, the monitoring application 414 includes a communication module 630, a remote devices management module 640, and a multiplex module 650.

The communication module 630 enables communication between the gateway 400, the client devices 102, 106, and the mobile devices 138, 190, 192. In one example embodiment, the communication module 630 includes a user authentication module 632, a user access policy module 634, a web server authentication module 636, and a transport module 638.

The user authentication module 632 authenticates a user at the client device or at a wireless mobile communication device based on a user profile of the user. An example of user authentication may include verifying the username and password provided by the wireless mobile communication device with a predefined user profile. The predefined user profile may be stored in the storage device 412 of the gateway or at the web server 110.

The user access policy module 634 limits or grants the user at the client device or at the wireless mobile communication device access to the monitoring and/or controlling devices connected to the gateway. For example, a user with limited privilege may have access to the monitoring data to a particular site (e.g. first floor only) or a specific monitoring device (e.g. HVAC only). On the other hand, a user with executive privilege may not only be able to view monitoring data and control security devices from more sites.

The web server authentication module 636 authenticates a communication between the gateway 400 and the web server 110. For example, the gateway transmits a unique token to the web server 110 for authentication prior to establishing the secured communication. Those of ordinary skills in the art will recognize that other means of authentication between the gateway and the web server 110 may be used.

The transport module 638 enables peer-to-peer communication between gateways. As such, a client device communicating with one gateway at a first location is also able to communicate with another gateway at a second location.

The remote devices management module 640 enables the client devices 102, 106 to monitor or control the monitoring or controlling devices connected or associated with the gateway 400. In one example embodiment, the remote devices management module 640 includes an analytics module 642, an event aggregation module 644, an event-based control module 646, and a client-based control module 648.

The analytics module 642 analyzes audio/video, and other detected changes from the monitoring devices and generates events based on the analysis. For example, the analytics module 642 is capable of determining how many people have entered or left an activity zone (e.g. a room, a hallway) in a video feed, the direction of the movement of individuals in a video feed, the temperature of individuals in a video feed, facial recognition of individuals in a video feed, and so forth. Events are generated based on the analysis and predefined user-configured settings. A user at a client device is able to configure the conditions for generating an event from the web browser 104 of the client device 102 or the client application 108 of the client device 106.

The event aggregation module 644 aggregates events generated by the analytics module 642. For example, events generated based on the analysis and predefined/user-configured settings are aggregated in a log stored in a storage device attached to the gateway, in a storage device attached to another gateway, in a storage device attached to the web server 110, or in a storage device connected to the client device.

The event-based control module 646 communicates a command to at least one controlling device connected to the corresponding gateway based on an event identified in event aggregation module 644 based on an event configuration. For example, an event comprises a temperature of a room reaching a predefined maximum temperature. The event-based control module 646 may communicate to the HVAC system to turn on the air conditioning system for the room if such event occurs.

The client-based control module 648 communicates a command to one or more controlling devices of the corresponding gateway based on a command initiated and communicated from the client device. For example, a user at the client device or at a wireless mobile communication device may initiate a command to pan a camera connected to the gateway. Such command would be communicated to the camera via the client-based control module 648.

The multiplex module 650 enables the devices associated with the gateway to send and receive at the same time video streams to, from, and between devices. In one example embodiment, the multiplex module 650 includes a broadcast module 652, a stream module 654, a control module 656, a feed interface module 658, and a distributive analytics module 660.

The broadcast module 652 enables the gateway to broadcast or send a video stream received from a wireless mobile communication device to other mobile devices. The video stream may be a live stream or a prerecorded video stream stored in the wireless mobile communication device.

The stream module 654 enables the gateway to receive a video stream or video feed from other devices associated with the corresponding gateway.

The control module 656 enables the wireless mobile communication device to monitor and control devices (e.g., camera, security) connected to the corresponding gateway. Examples of controls include turning the other devices on or off, turning the video stream from the other devices on or off, sending a command to record a video stream from one device to another device associated with the gateway.

The feed interface module 658 includes an interface (e.g., API) that allows the gateway to receive feeds from other devices such as devices that are not associated with the gateway.

The distributive analytics module 660 allows the gateway to distribute analytics processing among other devices associated with the gateway. For example, the video stream received from a first device may be distributed for processing with a second and third device. The results of the analytics processing may be provided to a fourth device.

FIG. 7 is a block diagram illustrating an example embodiment of a web server 110 also referred to as a web-based host. The web server 110 comprises a web-based gateway management application 702 and a storage device 710. The web-based gateway management application 702 identifies a gateway associated with a user at the client device or the wireless mobile communication device, authenticates with the user at the client device or the wireless mobile communication device, and authenticates with the identified gateway.

In one embodiment, the web-based gateway management application 702 includes a gateway directory manager 708, a user authentication module 704, a gateway authentication module 706, and a peer to peer (P2P) module 714. The gateway directory manager 708 identifies a gateway associated with a user profile. For example, a user may only be able to access a particular gateway or a particular set of devices connected to a gateway. As such, a west coast manager of an organization may be able to access monitored sites only from west coast stores of the organization. In contrast, a user with higher privileges may be able to access more gateways and devices. As such, the CEO of an organization with stores throughout the U.S. may be able to view monitoring data from all the stores in the U.S.

In another embodiment, the gateway directory manager 708 includes a service manager module 712 to enable add-on services to the user at the client device. For example, the add-on services include, but are not limited to, remote storage, remote audio, two-way audio, dynamic backup, or reporting based on the user profile.

The user authentication module 704 authenticates the web server 110 with the user at the client device or the wireless mobile communication device based on the user profile. For example, the web server 110 verifies the username and password of the user at the client device or the wireless mobile communication device.

The gateway authentication module 706 authenticates the identified gateway. For example, the web server 110 receives a unique token from the identified gateway to authenticate the identified gateway prior to establishing secured communication between the web server and the gateway.

The P2P module 714 keeps a directory of groups of mobile devices. For example, several mobile devices may form a particular group which may be also referred to as a mesh.

The storage device 710 may be used to store user profiles, tokens from gateways, a directory of gateways with corresponding devices, services from the gateways, a directory of gateways associated with a user profile, a directory of connected security devices associated with a user profile, a directory of meshes with their corresponding mobile devices.

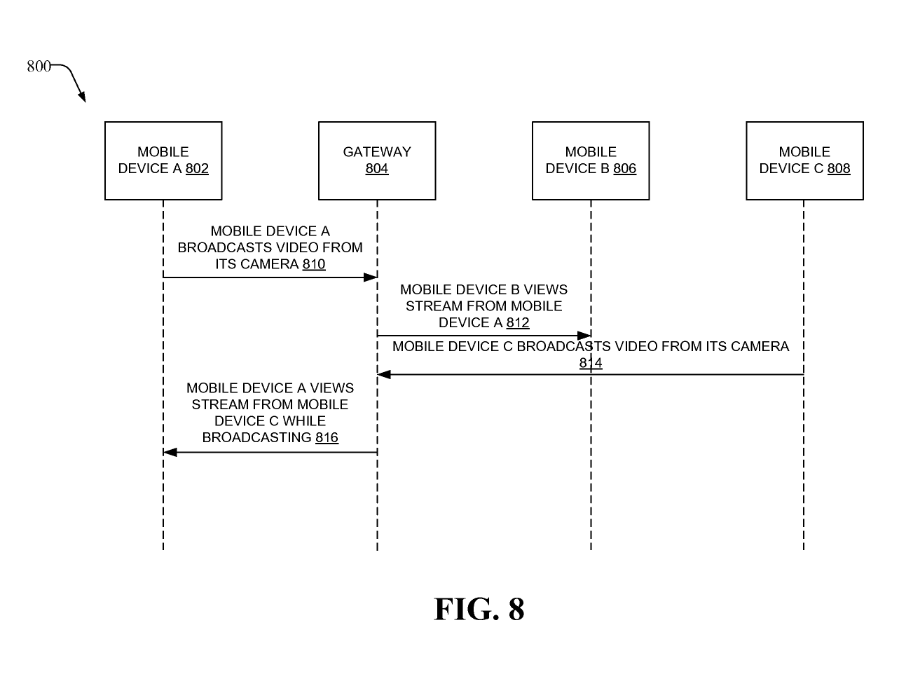

FIG. 8 is a ladder diagram of an example embodiment of an operation 800 for multiplex streaming between a first device and a second device connected to a gateway. Mobile device A 802 transmits a video stream captured with its camera to gateway 804 at operation 810. At operation 812, mobile device B 806 views the video stream from the mobile device A 802 via the gateway 804. Mobile device C 808 broadcasts a video stream from its camera to the gateway 804 at operation 814. At operation 816, the mobile device A 802 can review the video stream from mobile device C 808 while broadcasting a video stream from its camera to the gateway 804.

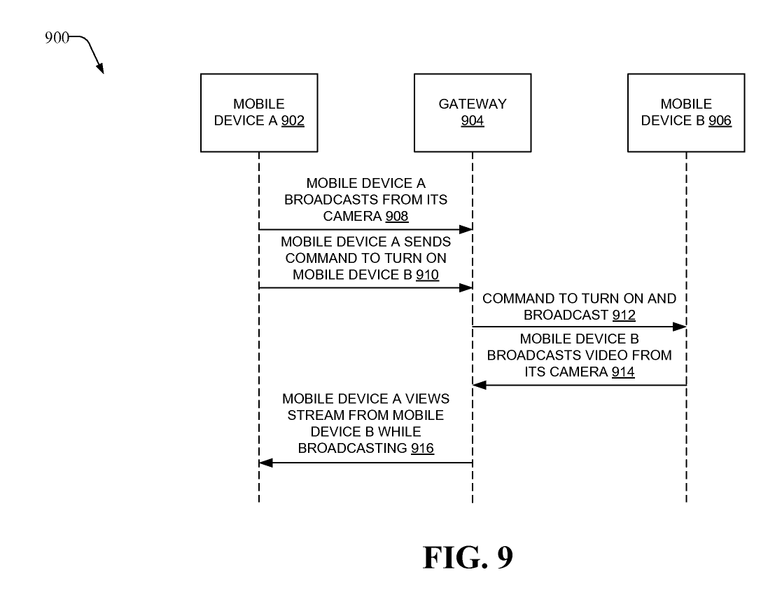

FIG. 9 is a ladder diagram of an example embodiment of a method 900 for multiplex streaming and control between a first device and a second device connected to a gateway. A mobile device A 902 broadcasts a video stream from its camera to the gateway 904 at operation 908. The mobile device A 902 also sends a message, at operation 910, that includes a command to the gateway 904 to turn on the video capture at mobile device B 906. At operation 912, the gateway 904 sends a command to turn on the camera at mobile device B 906 and to start broadcasting a video stream from the camera at mobile device B 906 to the gateway 904. At operation 916, the mobile device A 902 views the video stream from mobile device B 906 while broadcasting a video stream from its camera to the gateway 904.

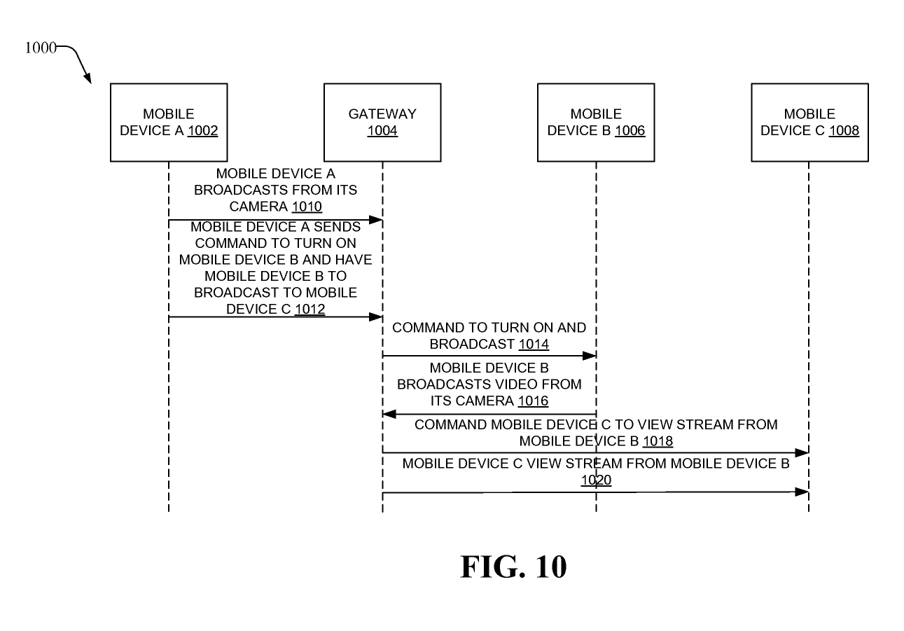

FIG. 10 is a ladder diagram of an example embodiment of a method 1000 for controlling, from a first device multiplex, streams from a second device to a third device connected to a gateway. A mobile device A 1002 sends a video stream captured with its camera to the gateway 1004 at operation 1010. At operation 1012, the mobile device A 1002 also sends a command to turn on the mobile device B 1006 and have mobile device B 1006 broadcast the video stream from mobile device B 1006 to mobile device C 1008. At operation 1014, the gateway 1004 sends a command to turn on the camera of mobile device B 1006 and to start broadcasting a video stream to the gateway 1004. At operation 1016, the mobile device B 1006 broadcasts a video stream from its camera to the gateway 1004 in response to the command from operation 1014. At operation 1018, the gateway 1004 sends a command to mobile device C 1008 to view the video stream from mobile device B 1006. At operation 1020, mobile device C 1008 accesses the video stream from mobile device B 1006 via the gateway 1004.

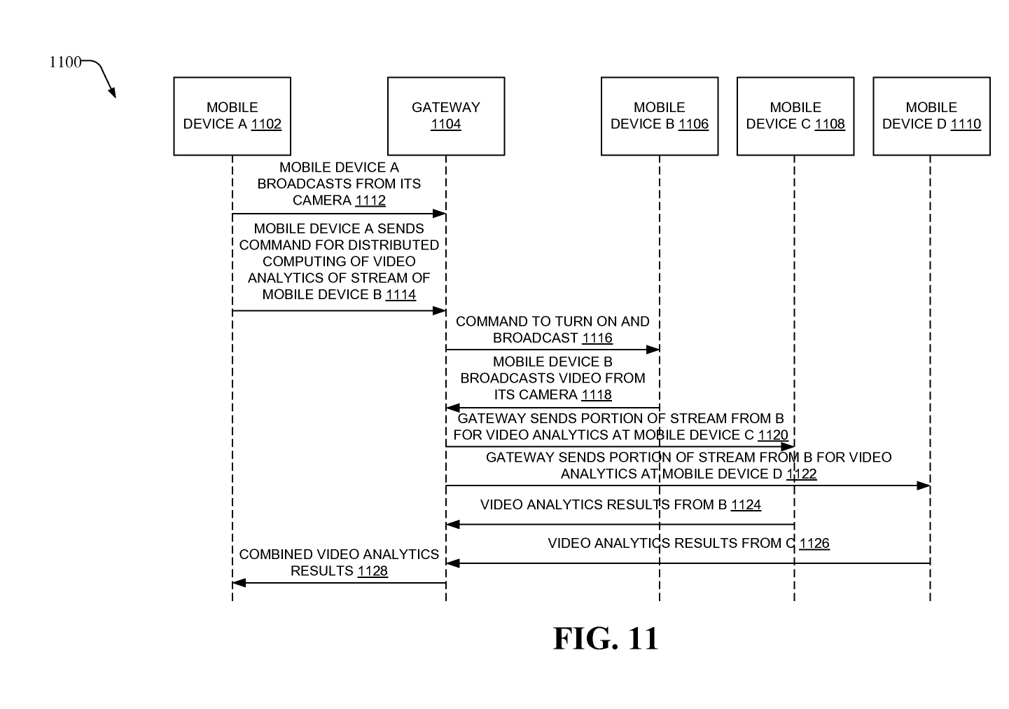

FIG. 11 is a ladder diagram of an example embodiment of a method 1100 for requesting, from a first device, distributive analytics of streams from a second device with third, fourth, and fifth devices. At operation 1112, a mobile device A 1102 starts broadcasting a video stream from its camera to a gateway 1104. At operation 1114, the mobile device A 1102 sends a command to the gateway 1104 for distributed computing of video analytics of the video stream from a mobile device B 1106. At operation 1116, the gateway 1104 sends a command to mobile device B 1106 to turn on and broadcast a video stream back to the gateway 1104. At operation 1118, mobile device B 1106 starts broadcasting a video stream from its camera to the gateway 1104. At operation 1120, the gateway 1104 sends a portion of the video stream from mobile device B 1106 for video analytics at mobile device C 1108. At operation 1122, the gateway 1104 sends another portion of the video stream from mobile device B 1106 for video analytics to mobile device D 1110. At operation 1122, video analytics results from mobile device C 1108 are sent back to the gateway 1104. Similarly at operation 1126, video analytics results from mobile device D 1110 are sent back to the gateway 1104. The video analytics results from mobile devices C 1108 and D 1110 are combined and sent to the mobile device A 1102 at operation 1128.

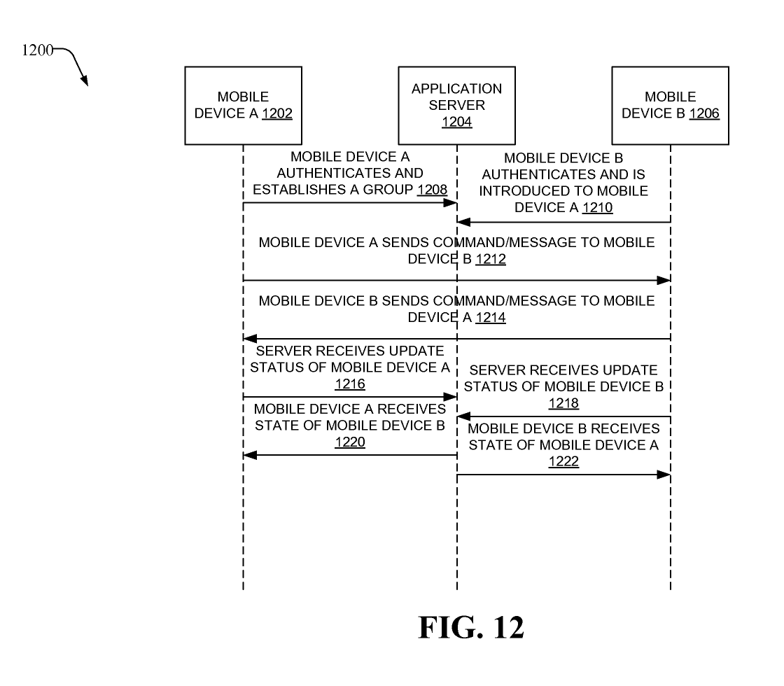

FIG. 12 is a ladder diagram of an example embodiment of a method 1200 for peer to peer multiplex streaming. At operation 1208, a mobile device A 1202 authenticates itself with an application server 1204 and establishes a group. Similarly at operation 1210, a mobile device B 1206 authenticates itself with the application server 1204, is introduced to the mobile device A 1202 and joins the group established by mobile device A 1202. The application server 1204 keeps track of all peer to peer groups and meshes. At operation 1212, the mobile device A 1202 sends a command or a message to the mobile device B 1206. In another embodiment, the mobile device A 1202 broadcasts the message to all devices in the group. At operation 1214, the mobile device B 1206 sends a command or a message to the mobile device A 1202. At operation 1216, the application server 1204 receives an update status of the mobile device A 1202. At operation 1218, the application server 1204 receives an update status of the mobile device B 1206. At operation 1220, the mobile device A 1202 receives the state of the mobile device B 1206 from the application server 1204. At operation 1222, the mobile device B 1206 receives the state of the mobile device A 1202 from the application server 1204.

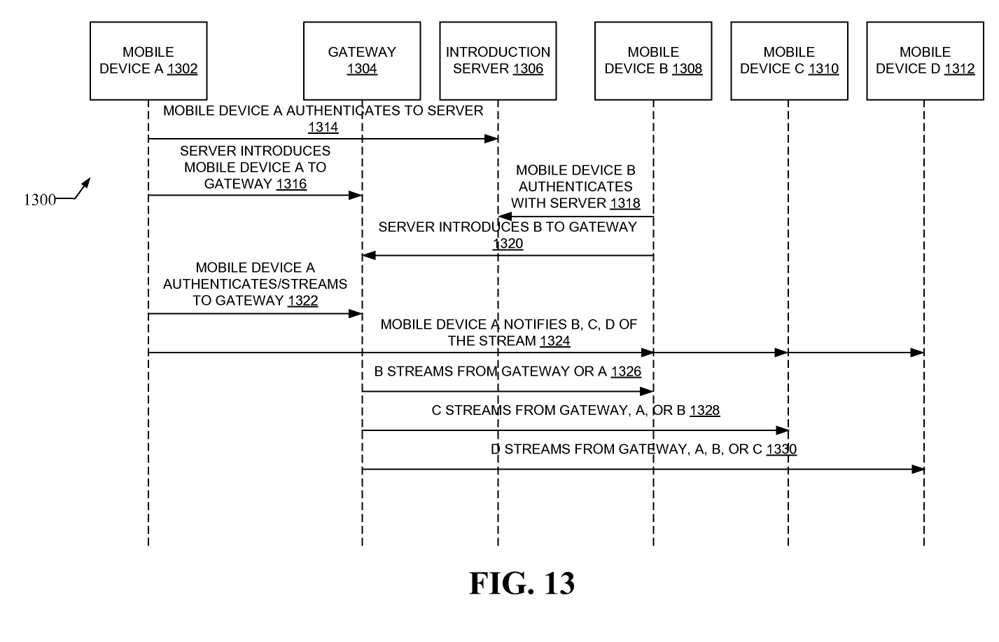

FIG. 13 is a ladder diagram of another example embodiment of a method 1300 for peer to peer multiplex streaming. At operation 1314, a mobile device A 1302 is authenticated with an introduction server 1306. At operation 1316, the introduction server 1306 introduces the mobile device A 1302 to a gateway 1304 associated with the mobile device A 1302. At operation 1318, a mobile device B 1308 is authenticated with the introduction server 1306. At operation 1320, the mobile device B 1308 is introduced to the gateway 1304 associated with the authentication of the mobile device B 1308. At operation 1322, the mobile device A 1302 is authenticated at the gateway 1304 and starts streaming a video stream to the gateway 1304. At operation 1324, the mobile device A 1302 notifies peer devices that are part of the group to which the mobile device A 1302 belongs. For example, the mobile device A 1302 notifies mobile device B 1308, mobile device C 1310, and mobile device D 1312 of the availability of the video stream from mobile device A 1302. At operation 1326, mobile device B 1308 can stream the mobile device A 1302's video stream from the gateway 1304 or directly from mobile device A 1302. At operation 1328, mobile device C 1310 can stream the mobile device A 1302's video stream from the gateway 1304, directly from mobile device A 1302, or directly from mobile device B 1308. At operation 1330, mobile device D 1312 can stream the mobile device A 1302's video stream from the gateway 1304, directly from mobile device A 1302, directly from mobile device B 1308, or directly from mobile device C 1310.

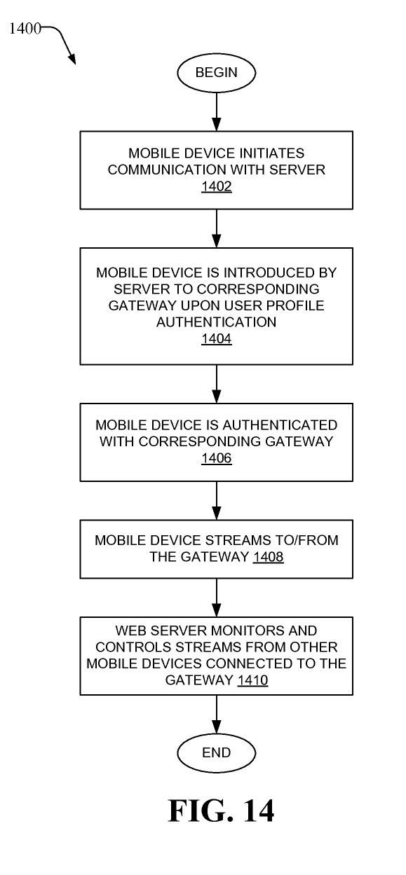

FIG. 14 is a flow diagram of an example embodiment of a method 1400 for multiplex streaming of devices associated with and connected to a gateway. At operation 1402, a mobile device initiates a communication with a server. At operation 1404, the mobile device is introduced by the server to a corresponding gateway upon authentication of a user profile from the mobile device. At operation 1406, the mobile device is authenticated with the corresponding gateway. At operation 1408, the mobile device streams to and from the gateway. In another embodiment, the mobile device can stream from other mobile devices therefore bypassing the gateway. At operation 1410, the server monitors and controls video streams from other mobile devices that are connected to or associated with the gateway.

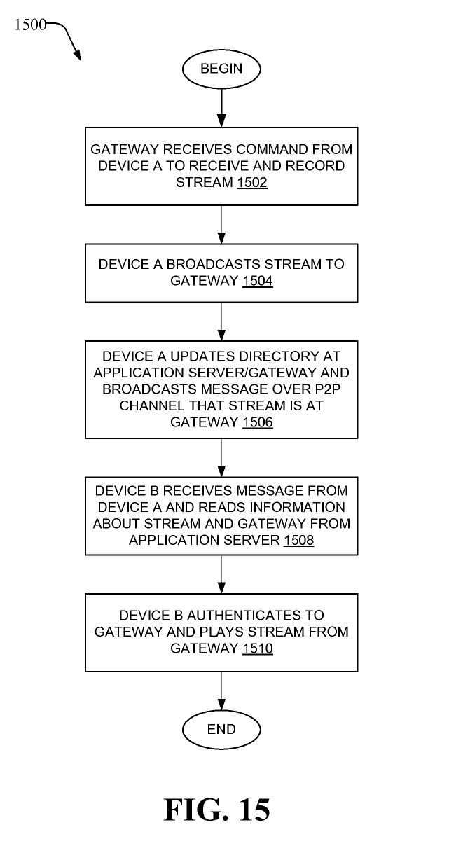

FIG. 15 is a flow diagram of another example embodiment of a method 1500 for multiplex streaming of devices associated with and connected to a gateway. At operation 1502, a gateway receives a command from device A to receive and record a video stream. At operation 1504, device A broadcast a video stream to the gateway. At operation 1506, device A updates a directory at the application server and/or gateway and broadcasts a message over a peer-to-peer channel announcing that the device A is streaming to the gateway. At operation 1508, device B receives the broadcast message from device A and reads information about the stream and gateway from the application server. At operation 1510, device B authenticates with the gateway and plays the video stream from the gateway.

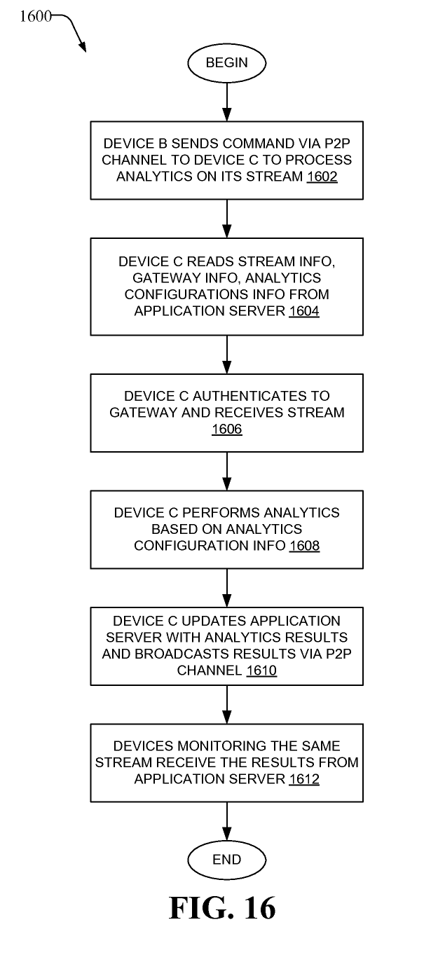

FIG. 16 is a flow diagram of an example embodiment of a method 1600 for distributive analytics of streams from devices associated and connected to a gateway. At operation 1602, device B sends a command via a peer-to-peer channel to device C to perform analytics on its stream. Device C reads stream information, gateway information, and analytics configuration information from the application server at operation 1604. At operation 1606, the device C authenticates with the gateway and receives the stream. At operation 1608, device C performs analytics based on the analytics configuration information. At operation 1610, device C updates the application server with an analytics results and broadcast the results via a peer-to-peer channel. At operation 1612, devices that are monitoring the same stream receive the results from the application server.

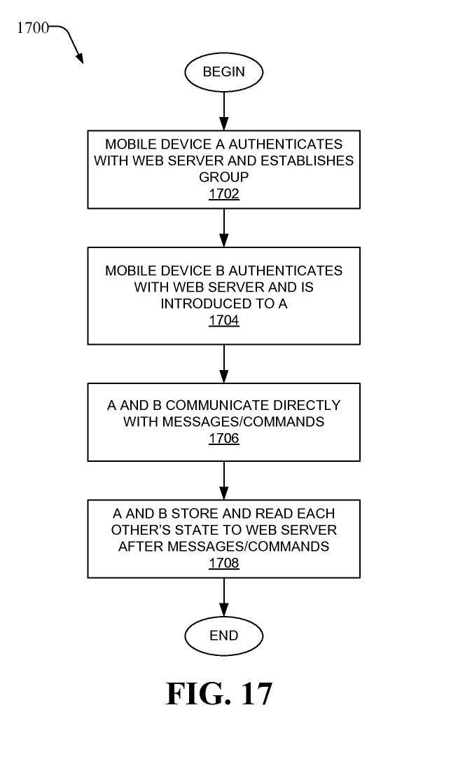

FIG. 17 is a flow diagram of an example embodiment of a method 1700 for peer to peer streaming of devices associated and connected to a gateway. At operation 1702, mobile device A authenticates with a Web server and establishes a group. At operation 1704, mobile device B authenticates with the Web server and is introduced to mobile device A. At operation 1706, mobile devices A and B communicate directly with messages and commands. At operation 1708, mobile devices A and B store and read each other's state to the Web server after receiving the messages and commands.

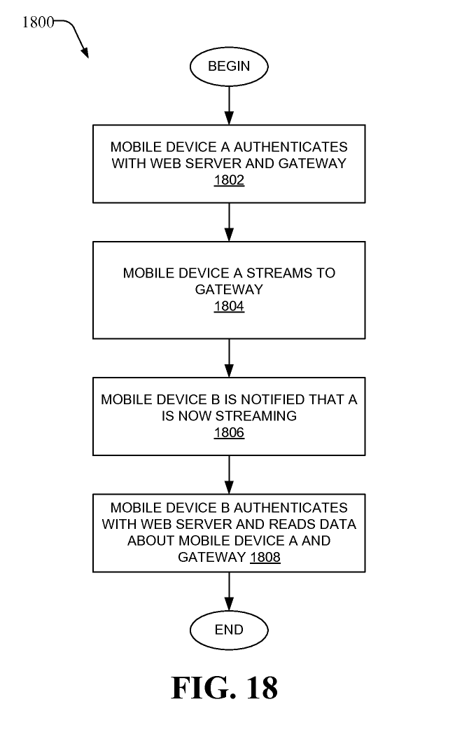

FIG. 18 is a flow diagram of another example embodiment of a method 1800 for peer to peer streaming of devices associated and connected to a gateway. At operation 1802, a mobile device A authenticates with a Web server and a gateway. The mobile device A streams to the gateway at operation 1804. At operation 1806, a mobile device B is notified that a stream from mobile device A is available. At operation 1808, mobile device B authenticates with the Web server and reads data about mobile device A and the gateway.

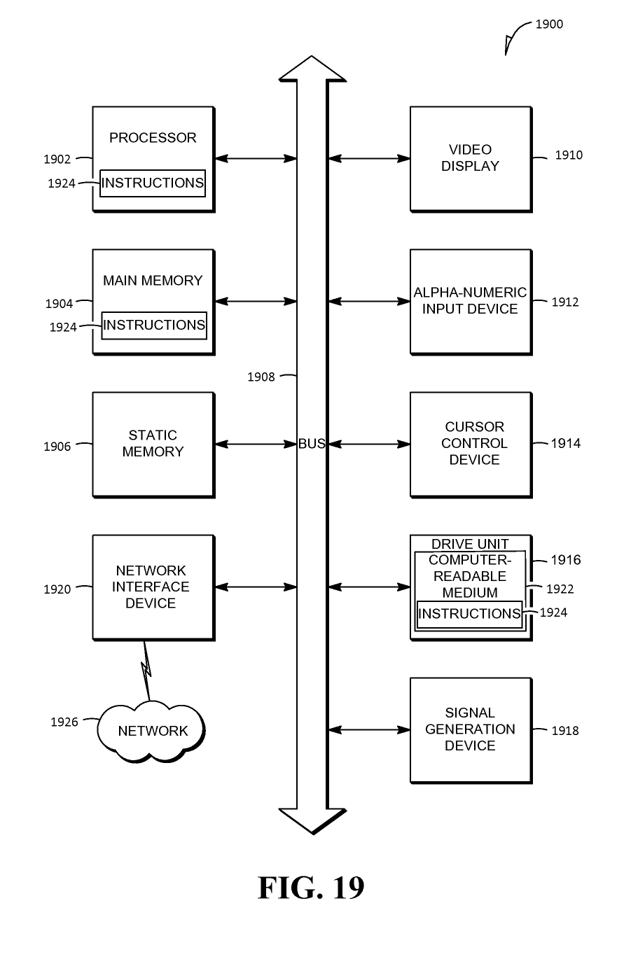

FIG. 19 shows a diagrammatic representation of a machine in the example form of a computer system 1900 within which a set of instructions 1924 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1900 includes a processor 1902 (e.g., a central processing unit (CPU), a graphics processing unit (GPU) or both), a main memory 1904 and a static memory 1906, which communicate with each other via a bus 1908. The computer system 1900 may further include a video display unit 1910 (e.g., a liquid crystal display (LCD) or a cathode ray tube (CRT)). The computer system 1900 also includes an alphanumeric input device 1912 (e.g., a keyboard), a user interface (UI) navigation (or cursor control) device 1914 (e.g., a mouse), a disk drive unit 1916, a signal generation device 1918 (e.g., a speaker) and a network interface device 1920.

The disk drive unit 1916 includes a computer-readable medium 1922 on which is stored one or more sets of data structures and instructions 1924 (e.g., software) embodying or utilized by any one or more of the methodologies or functions described herein. The instructions 1924 may also reside, completely or at least partially, within the main memory 1904 and/or within the processor 1902 during execution thereof by the computer system 1900, the main memory 1904 and the processor 1902 also constituting machine-readable media.

The instructions 1924 may further be transmitted or received over a network 1926 via the network interface device 1920 utilizing any one of a number of well-known transfer protocols (e.g., HTTP).

While the machine-readable medium 1922 is shown in an example embodiment to be a single medium, the term “machine-readable medium” should be taken to include a single medium or multiple media (e.g., a centralized or distributed database, and/or associated caches and servers) that store the one or more sets of instructions 1924. The term “machine-readable medium” shall also be taken to include any medium that is capable of storing, encoding or carrying a set of instructions for execution by the machine and that cause the machine to perform any one or more of the methodologies of the present inventive subject matter, or that is capable of storing, encoding or carrying data structures utilized by or associated with such a set of instructions. The term “machine-readable medium” shall accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A gateway comprising:
a communication module configured to communicate with a first mobile device and a second mobile device both introduced to the gateway by a web server;
a multiplex module configured to multiplex a first video stream and a second video stream at the first mobile device, the multiplex module comprising:
a stream module configured to receive the first video stream from the first mobile device,
a control module configured to receive a command from the first mobile device to remotely control the second mobile device to generate the second video stream from the second mobile device, and
a broadcast module configured to broadcast the second video stream to the first mobile device while receiving the first video stream from the first mobile device.

2. The gateway of claim 1, wherein the broadcast module is configured to broadcast the first video stream to the second mobile device,
wherein the stream module is configured to receive a third video stream from a third mobile device, and
wherein the broadcast module is configured to broadcast the third video stream to the first mobile device while receiving the first video stream from the first mobile device.

3. The gateway of claim 1, wherein the command includes a request to broadcast the second video stream to a third mobile device associated with the gateway,
wherein the broadcast module is configured to broadcast the second video stream from the second mobile device to the third mobile device.

4. The gateway of claim 1, further comprising:
a distributive analytics module configured to broadcast a first portion of the first video stream to the second mobile device and a second portion of the first video stream to a third mobile device associated with the gateway, to receive analytics results from the second mobile device and the third mobile device, to provide the analytics results to the first mobile device, the second mobile device configured to perform video analytics on the first portion of the first video stream, the third mobile device configured to perform video analytics on the second portion of the first video stream.

5. The gateway of claim 1, further comprising:
a distributive analysis module configured to broadcast the second video stream to a third mobile device associated with the gateway, to receive analytics results from the third mobile device, to provide the analytics results to the first mobile device, the third mobile device configured to perform video analytics on the second video stream.

6. The gateway of claim 1, further comprising:
a feed interface module configured to interface with a device not associated with the gateway and to receive a video feed from the device.

7. The gateway of claim 1, wherein the multiplex module is configured to establish a peer-to-peer network between the first mobile device and the second mobile device in response to an authentication of the first mobile device and the second mobile device at the web server, to notify the second mobile device of the first video stream from the first mobile device to the gateway, and to notify the second mobile device of the first video stream, the second mobile device receiving the first video stream from the gateway or directly from the first mobile device.

8. The gateway of claim 7, wherein the multiplex module is configured to direct a third mobile device joining the peer-to-peer network in response to an authentication of the third mobile device at the web server to access the first video stream from the gateway, from the first mobile device, or from the second mobile device.

9. The gateway of claim 1, further comprising:
a remote device management module configured to aggregate data from the first mobile device and monitor data generated by a security device coupled to the gateway, to communicate the aggregated data to a client device, and to control the security device in response to a request from the first mobile device.

10. The gateway of claim 9, wherein the gateway comprises:
a user authentication module configured to authenticate a user at the first mobile device based on a profile of the user at the first mobile device;
a user access policy module configured to limit or grant the user at the first mobile device access to the security device;
a web server authentication module configured to authenticate a communication between the gateway and the web server; and
a transport module configured to enable peer-to-peer communication between gateways, the first mobile device, and the web server,
wherein the web server comprises a web-based gateway management application configured to identify a gateway associated with a user at the first mobile device, to authenticate with the user at the first mobile device, to authenticate with the identified gateway, and to correlate the identified gateway with the other gateways.

11. A computer-implemented method comprising:
communicating with a first mobile device and a second mobile device both introduced to a gateway by a web server; and
multiplexing a first video stream and a second video stream at the first mobile device, the multiplexing comprising receiving the first video stream from the first mobile device, receiving a command from the first mobile device to remotely control the second mobile device to generate the second video stream from the second mobile device, broadcasting the second video stream to the first mobile device while receiving the first video stream from the first mobile device.

12. The computer-implemented method of claim 11, further comprising:
broadcasting the first video stream to the second mobile device,
receiving a third video stream from a third mobile device; and
broadcasting the third video stream to the first mobile device while receiving the first video stream from the first mobile device.

13. The computer-implemented method of claim 11, wherein the command includes a request to broadcast the second video stream to a third mobile device associated with the gateway, and
broadcasting the second video stream from the second mobile device to the third mobile device.

14. The computer-implemented method of claim 11, further comprising:
broadcasting a first portion of the first video stream to the second mobile device and a second portion of the first video stream to a third mobile device associated with the gateway;
receiving analytics results from the second mobile device and the third mobile device; and
providing the analytics results to the first mobile device, the second mobile device configured to perform video analytics on the first portion of the first video stream, the third mobile device configured to perform video analytics on the second portion of the first video stream.

15. The computer-implemented method of claim 11, further comprising:
broadcasting the second video stream to a third mobile device associated with the gateway;
receiving analytics results from the third mobile device; and
providing the analytics results to the first mobile device, the third mobile device configured to perform video analytics on the second video stream.

16. The computer-implemented method of claim 11, further comprising:
interfacing with a device not associated with the gateway and receiving a video feed from the device.

17. The computer-implemented method of claim 11, further comprising:
establishing a peer-to-peer network between the first mobile device and the second mobile device in response to an authentication of the first mobile device and the second mobile device at the web server;
notifying the second mobile device of the first video stream from the first mobile device to the gateway;
notifying the second mobile device of the first video stream, the second mobile device receiving the first video stream from the gateway or directly from the first mobile device; and
directing a third mobile device joining the peer-to-peer network in response to an authentication of the third mobile device at the web server to access the first video stream from the gateway, from the first mobile device, or from the second mobile device.

18. The computer-implemented method of claim 11, further comprising:
aggregating data from the first mobile device and monitoring data generated by a security device coupled to the gateway;
communicating the aggregated data to a client device; and
controlling the security device in response to a request from the first mobile device.

19. The computer-implemented method of claim 18, further comprising:
authenticating a user at the first mobile device based on a profile of the user at the first mobile device;
limiting and granting the user at the first mobile device access to the security device;
authenticating a communication between the gateway and the web server; and
enabling peer-to-peer communication between gateways, the first mobile device, and the web server,
wherein the web server comprises a web-based gateway management application configured to identify a gateway associated with a user at the first mobile device, to authenticate with the user at the first mobile device, to authenticate with the identified gateway, and to correlate the identified gateway with other gateways.

20. A non-transitory computer-readable storage medium storing a set of instructions that, when executed by a processor, cause the processor to perform operations, comprising:
communicating with a first mobile device and a second mobile device both introduced to a gateway by a web server; and
multiplexing a first video stream and a second video stream at the first mobile device, the multiplexing comprising receiving the first video stream from the first mobile device, receiving a command from the first mobile device to remotely control the second mobile device to generate the second video stream from the second mobile device, and broadcasting the second video stream to the first mobile device while receiving the first video stream from the first mobile device.
